(19) United States
(12) Patent Application Publication
(10) Pub. No.: US 2017/0109102 A1
(43) Pub. Date: Apr. 20, 2017

(54) USAGE OF SSD NVDRAM BY UPPER SOFTWARE LAYERS

(71) Applicant: Elastifile Ltd., Herzliya (IL)

(72) Inventors: Erez Yaffe, Tel Aviv (IL); Renana Frim, Tel Aviv (IL); Avraham Meir, Rishon LeZion (IL); Ezra Hoch, Tel Aviv (IL); Allon Cohen, Los Altos, CA (US); Eyal Lotem, Pardes Hana-Karkur (IL); Shahar Frank, Ramat Hasharon (IL)

(21) Appl. No.: 15/000,044

(22) Filed: Jan. 19, 2016

Related U.S. Application Data
(60) Provisional application No. 62/243,153, filed on Oct. 19, 2015.

(51) Int. Cl. G06F 3/06

(52) U.S. Cl. CPC G06F 3/0685; G06F 3/0604; G06F 3/0617; G06F 3/064

(57) ABSTRACT

An apparatus includes a storage device and a processor. The storage device includes a non-volatile storage including non-volatile memory media, and a Non-Volatile Dynamic Random Access Memory (NVDRAM). The processor is configured to run a software application that supports at least a first command for storing first information in the non-volatile storage of the storage device, and a second command for storing second information in the NVDRAM of the storage device.

### CROSS-REFERENCE TO RELATED APPLICATIONS

This application claims the benefit of U.S. Provisional Patent Application 62/243,153, filed Oct. 19, 2015, whose disclosure is incorporated herein by reference.

### FIELD OF THE INVENTION

The present invention relates generally to data storage, and particularly to usage of storage-device Non-Volatile Dynamic Random Access Memory (NVDRAM) by upper software layers.

### BACKGROUND OF THE INVENTION

Non-volatile storage devices often comprise some volatile memory used for internal management. For example, Flash-memory-based Solid State Drives (SSDs) often comprise a Dynamic Random Access Memory (DRAM) that is used for internal management of the SSD.

### SUMMARY OF THE INVENTION

An embodiment of the present invention that is described herein provides an apparatus including a storage device and a processor. The storage device includes a non-volatile storage including non-volatile memory media, and a Non-Volatile Dynamic Random Access Memory (NVDRAM). The processor is configured to run a software application that supports at least a first command for storing first information in the non-volatile storage of the storage device, and a second command for storing second information in the NVDRAM of the storage device.

In some embodiments, the NVDRAM includes a volatile Dynamic Random Access Memory (DRAM) and circuitry for protecting content of the DRAM from power interruption. In an embodiment, the processor further supports a third command for committing at least part of the second information from the NVDRAM to the non-volatile storage.

In a disclosed embodiment, the storage device includes a controller, which is configured to communicate with the processor and which recognizes and supports the first and second commands. In an example embodiment, the storage device includes a Solid State Drive (SSD), and the non-volatile memory media includes Flash memory. In some embodiments, the software application includes a File System (FS).

In some embodiments, the processor, using the software application, is configured to format data for storage in memory blocks having a fixed size, to store the memory blocks in the non-volatile storage using the first command, and to accumulate remainders of the data that exceed an integer number of the memory blocks in the NVDRAM using the second command. The processor, using the software application, may be configured to commit the accumulated remainders of the data to the non-volatile storage when a size of the accumulated remainders exceeds the fixed size of the memory blocks.

In other embodiments, the processor, using the software application, is configured to store data in the non-volatile storage using the first command, and to accumulate metadata relating to the data in the NVDRAM using the second command. The processor, using the software application, may be configured to commit the accumulated metadata to the non-volatile storage when a size of the accumulated metadata exceeds a predefined size. In an embodiment, the metadata accumulated in the NVDRAM includes journaling information. In an embodiment, the data stored in the non-volatile storage includes a file, and the metadata accumulated in the NVDRAM includes a first indication of a most-recent time the file was accessed, and/or a second indication of the most-recent time the file was modified.

In yet other embodiments, the processor, using the software application, is configured to initially store a data item in the NVDRAM using the second command, to check whether at least a predefined number of copies of the data item already exists in the non-volatile storage, and, if the predefined number of copies does not exist, to commit the data item from the NVDRAM to the non-volatile storage. The processor, using the software application, may be configured to discard the data item from the NVDRAM if the predefined number of copies exists in the non-volatile storage.

There is additionally provided, in accordance with an embodiment of the present invention, a method including running a software application on a processor that communicates with a storage device. The storage device includes non-volatile storage including non-volatile memory media, and a Non-Volatile Dynamic Random Access Memory (NVDRAM). First information is stored in the non-volatile storage of the storage device, using a first command supported by the software application. Second information is stored in the NVDRAM of the storage device, using a second command supported by the software application. At least part of the second information is committed from the NVDRAM to the non-volatile storage.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system, in accordance with an embodiment of the present invention;

FIG. 2 is a flow chart that schematically illustrates a method for storing data in fixed-size memory blocks, in accordance with an embodiment of the present invention;

FIG. 3 is a flow chart that schematically illustrates a method for storage of data and metadata, in accordance with an embodiment of the present invention; and

FIG. 4 is a flow chart that schematically illustrates a method for data storage and de-duplication, in accordance with an embodiment of the present invention.

### DETAILED DESCRIPTION OF EMBODIMENTS

### Overview

Embodiments of the present invention that are described herein provide improved methods and systems for data storage in storage devices such as Solid State Drives (SSDs). In the disclosed embodiments, one or more software applications store data in a storage device that comprises both non-volatile storage such as Flash memory, and a Non-Volatile Dynamic Random Access Memory (NVDRAM). The disclosed techniques expose the NVDRAM of the storage device directly to the applications.

In order to take advantage of the direct access to the NVDRAM, a software application typically supports a first command for storing information in the non-volatile storage of the storage device, a second command for storing information in the NVDRAM of the storage device, and optionally a third command for committing information from the NVDRAM to the non-volatile storage. Alternatively to the third command, information may be committed from the NVDRAM to the non-volatile storage using a conventional copy command. The controller of the storage device (e.g., SSD controller) is typically configured to recognize and support these commands.

Direct access of applications to the storage device NVDRAM can be used in various ways to improve storage performance. Several examples are described herein. In one embodiment, a File System (FS) stores files in the storage device using memory blocks having a fixed size. In practice, the sizes of the data items being written are often not integer numbers of the memory block size. For example, when writing a small file, the file size may not be an integer number of the memory block size. When writing data into a file, the data written in a given write command may not be an integer number of the memory block size. As yet another example, the FS may compress the data before storage, resulting in variable-size data that is usually not an integer number of the memory block size.

In this embodiment, the FS divides the storage operation in two. The part of a data item that fits into an integer number of memory blocks is sent for storage in the non-volatile storage. The remainders of various data items, i.e., the chunks of the data items that exceed an integer number of memory blocks, are accumulated by the FS in the storage device NVDRAM. When the accumulated remainders of the data items reach or exceed the size of a memory block, the FS commits a block of remainders to the non-volatile storage.

In another embodiment, the FS stores files, objects or other data in the non-volatile storage, and accumulates metadata relating to the data in the NVDRAM. Metadata may comprise, for example, journaling information. Again, the FS may commit the metadata from the NVDRAM to the non-volatile storage when the size of the accumulated metadata reaches or exceeds the memory block size.

In yet another embodiment, the FS uses the NVDRAM for storing metadata that changes frequently, without necessarily committing it to the non-volatile storage. For example, the FS may use the NVDRAM for storing parameters such as the mTime of a file (the most recent time the file was modified) or the aTime of a file (the most recent time the file was accessed).

In another embodiment, the FS uses the NVDRAM for temporary storage of data items (e.g., memory pages) during de-duplication. In this embodiment, the FS initially stores a data item in the NVDRAM, and then checks whether a copy of this data item already exists in the non-volatile storage. If no existing copy is found, the FS commits the data item from the NVDRAM to the non-volatile storage. If a copy already exists, the FS discards the data item from the NVRAM.

The techniques described herein improve system performance because, for example, they prevent applications from performing frequent writes of small chunks of data to the non-volatile storage. As a result, the endurance of the non-volatile storage improves significantly, and I/O amplification and write amplification are reduced. In addition, since storage in NVDRAM is considerably faster than storage in non-volatile storage, the disclosed techniques may also increase storage throughput and reduce latency. At the same time, since the NVDRAM is resilient to power interruption, the disclosed techniques do not compromise storage reliability or data integrity.

### System Description

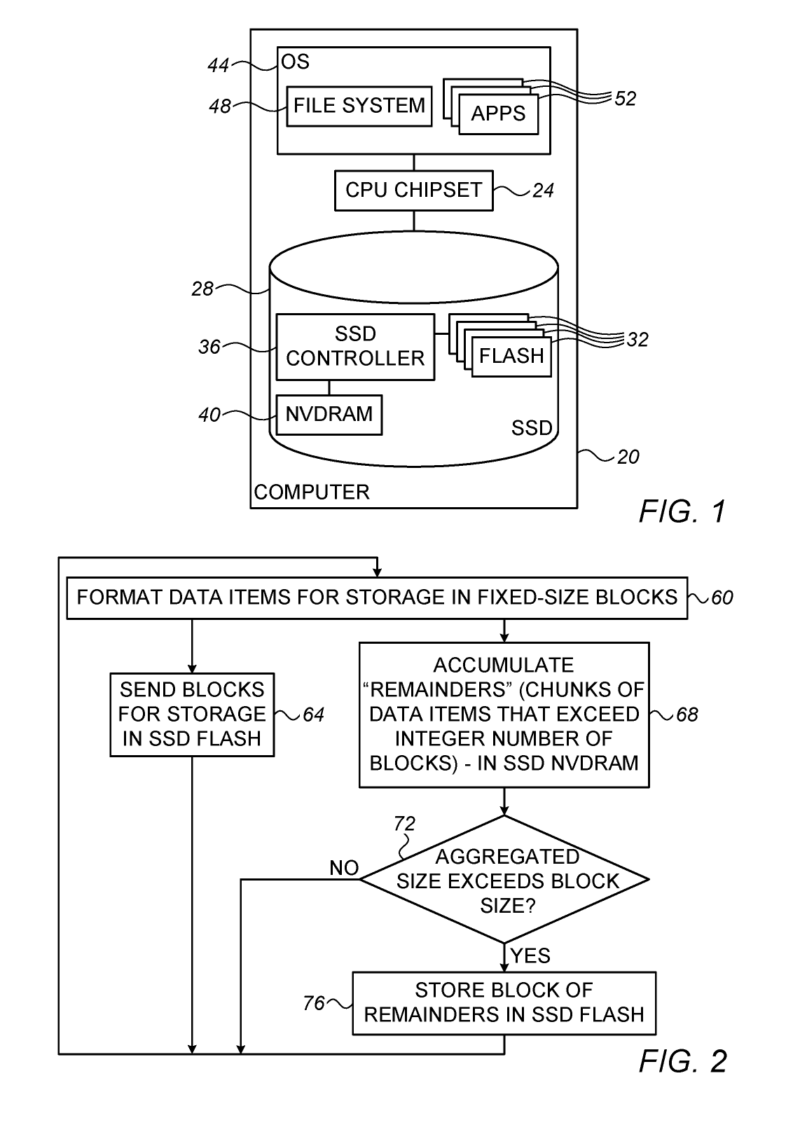

FIG. 1 is a block diagram that schematically illustrates a computing system, in accordance with an embodiment of the present invention. In the present example, the computing system comprises a computer 20, which comprises a Central Processing Unit (CPU) chipset 24 that stores data in a Solid State Drive (SSD) 28.

The example embodiment of a single computer and a single SSD is chosen for the sake of clarity. In alternative embodiments, the disclosed techniques can be implemented in any other suitable system in which a processor stores information in a storage device. Examples of such systems include data centers, enterprise storage systems and cloud computing systems, to name just a few.

SSD 28 typically receives external electrical power supply from computer 20. The external electrical power supply is not always available and may be interrupted, for example, when the computer is off or for any other reason.

SSD 28 comprises a large non-volatile storage that is used for persistent storage. The non-volatile storage is implemented using suitable non-volatile memory media that retains its content regardless of availability or absence of the external electrical power supply. In the present example the non-volatile storage comprises a plurality of Flash memory devices 32. In alternative embodiments, the non-volatile storage of SSD 28 may be implemented using any other suitable non-volatile media.

In addition, SSD 28 comprises a smaller, auxiliary Non-Volatile Dynamic Random Access Memory (NVDRAM) 40. In some embodiments, NVDRAM 40 is implemented using one or more Dynamic Random Access Memory (DRAM) devices, and suitable circuitry that protects the DRAM content from interruption of the external electrical power supply. The DRAM itself is volatile, i.e., does not retain its content in the absence of external electrical power. The circuitry typically comprises an internal energy store, such as a backup battery or capacitor, which provides the DRAM with sufficient electrical power for preserving its content during external power supply interruptions. Alternatively, any other suitable NVDRAM implementation can be used.

SSD 28 further comprises an SSD controller 36 that manages the various storage operations of the SSD, and communicates with CPU chipset 24 of computer 20.

Computer 20 runs a certain Operating System (OS) 44, such as Linux or Windows, which comprises a File System (FS) 48 and runs various user applications 52. In alternative embodiments, the FS may comprise a distributed network-FS.

In the present example, FS 48 is a software component of OS 44, which is used for storing files for user applications 52 as well as for the OS itself. In the present context, OS 44, FS 48 and user applications 52 are regarded as software applications that run on CPU chipset 24 and store data in SSD 28. Additionally or alternatively, the disclosed techniques can be used in a similar manner with any other suitable software applications that run on CPU chipset 24 and store data in SSD 28.

In some embodiments, the command interface between CPU chipset 24 and SSD controller 36 exposes NVDRAM 40 directly to FS 48 and/or user applications 52. In other words, NVDRAM 40 is not used exclusively by SSD controller 36 for SSD management purposes, but can be used as a storage resource by applications running in computer 20.

NVDRAM 40 can be exposed to the applications in various ways. Typically, the command interface between CPU chipset 24 and SSD controller 36 supports at least two commands:
A “first command” for storing information in the non-volatile storage, i.e., in Flash devices 32.
A “second command” for storing information in NVDRAM 40.

In some embodiments, command interface between CPU chipset 24 and SSD controller 36 further supports a “third command” for committing information from NVDRAM 40 to Flash devices 32. In alternative embodiments, information may be committed from NVDRAM 40 to Flash devices 32 using a conventional copy operation instead of a dedicated third command. The description that follows refers to the use of all three commands, by way of example.

An application that supports these commands is able to decide, for example, which information is to be stored in the NVDRAM, which information is to be stored in Flash memory, and to decide when to commit certain information from the NVDRAM to the Flash. Several example use cases for this mechanism are described in detail further below.

The configuration of computer 20 shown in FIG. 1 is an example configuration that is chosen purely for the sake of conceptual clarity. In alternative embodiments, the disclosed techniques can be implemented with any other suitable computer or computing system configuration. The different elements of computer 20 may be implemented using suitable hardware, using software, or using a combination of hardware and software elements.

In some embodiments, CPU chipset 24 and/or SSD controller 36 may comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Exposing SSD NVDRAM to Operating System, File System or Other Applications

The description that follows gives several examples that demonstrate how applications running in computer 20 can exploit the direct access to NVDRAM 40 of SSD 28. The examples below refer mainly to usage of the NVDRAM by File System (FS) 48, but the disclosed techniques can be used in a similar manner by any other application. Moreover, the disclosed techniques are in no way limited to the examples given below.

FIG. 2 is a flow chart that schematically illustrates a method for storing data, in accordance with an embodiment of the present invention. In this example, FS 48 is configured to store data in SSD 28 using fixed-size memory blocks. An example block size used in the present example is 4 KB, but any other suitable block size can be used.

In practice, however, the actual sizes of data items sent for storage by FS 48 in individual write commands are often not integer numbers of the memory block size. In the present context, a data item may comprise, for example, an entire file, a portion of data written into a file in a write command, a compressed portion of data, or any other suitable type of data item.

In other words, a data item often fits into some integer number of memory blocks, plus a “remainder” that is smaller than the block size, i.e., a chunk of the data item that exceeds the integer number of blocks. In some embodiments, FS 48 stores the parts of the data items that fit into integer numbers of blocks in Flash memory 32, and accumulates the remainders of the various data items in NVDRAM 40.

The method of FIG. 2 begins with FS 48 formatting one or more data items in blocks having a fixed size, at a formatting step 60. At a non-volatile storage step 64, FS 48 sends the blocks for storage in Flash memory 32 using the “first command” described above. At an NVDRAM accumulation step 68, FS 48 accumulates the remainders of the various data items in NVDRAM 40 using the “second command” described above.

At a data size checking step 72, FS 48 checks whether the aggregated size of the data-item remainders reaches or exceeds the fixed block size (4 KB in the present example). If so, FS 48 commits a memory block containing accumulated remainders from NVDRAM 40 to Flash memory 32, e.g., using the “third command” described above, at a remainder commit step 76. The memory block being committed in this step often comprises remainders of multiple data items.

In an embodiment, FS 48 stores the data items in SSD in compressed form, i.e., compresses the data-item content before storage. In this embodiment, FS 48 populates the integer number of blocks with compressed data, and generates the remainders from the compressed data remaining after formatting the blocks.

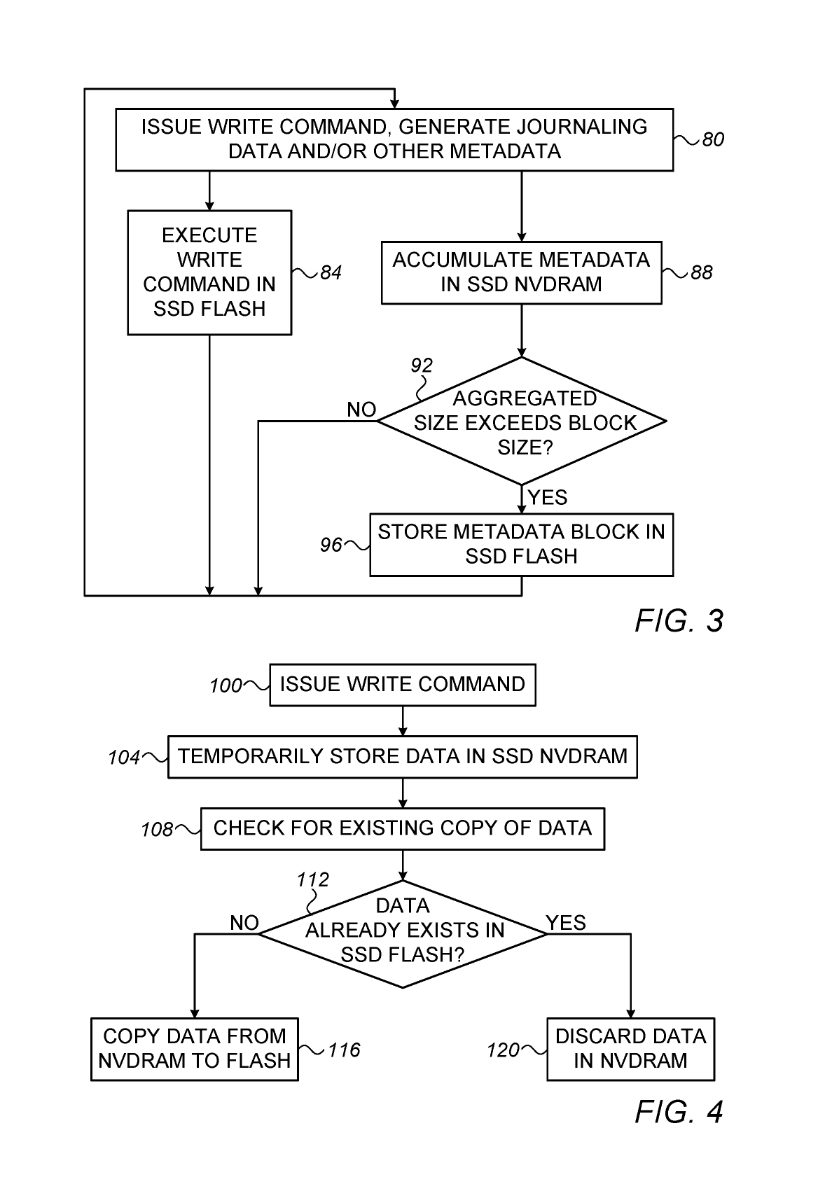

FIG. 3 is a flow chart that schematically illustrates a method for storage of data and metadata, in accordance with another embodiment of the present invention. In this embodiment, FS 48 stores data (e.g., files or objects) in Flash memory 32, and accumulates metadata relating to the data in NVDRAM 40.

The method of FIG. 3 begins with FS 48 issuing a write command for writing certain data to SSD 28, and generates metadata relating to the data, at a data & metadata generation step 80. One example of metadata is journaling information that specifies changes performed in the data since a previous write operation, or otherwise enables roll-back of the write operation in case of failure. Journaling information for a write command is typically small, e.g., on the order of several tens to several hundred bytes. Alternatively, any other suitable kind of metadata can be generated.

At a write execution step 84, FS 48 executes the write command in Flash memory 32 using the “first command.” At a metadata accumulation step 88, FS 48 writes the metadata generated at step 80 to NVDRAM 40 using the “second command.” Thus, the metadata of various write commands gradually accumulates in NVDRAM 40.

At a metadata size checking step 92, FS 48 checks whether the size of the accumulated data in NVDRAM 40 reaches or exceeds the block size used for storage (e.g., KB). If so, FS 48 commits a memory block containing accumulated metadata from NVDRAM 40 to Flash memory 32, e.g., using the “third command,” at a metadata commit step 96. The memory block being committed in this step typically comprises metadata of multiple write commands, possibly belonging to different files.

In alternative embodiments, FS 48 does not necessarily commit all metadata to Flash memory 32. In some embodiments, FS 48 uses NVDRAM 40 for storing metadata that changes frequently, without necessarily committing it to the non-volatile storage, in order to improve the endurance of the Flash memory media.

Metadata parameters that change frequently comprise, for example, an “mTime” parameter of a file, which indicates the most recent time the file was modified, or an “aTime” parameter of a file, which indicates the most recent time the file was accessed. In an embodiment, FS stores these frequently-changing metadata parameters in NVDRAM 40 without committing them to Flash memory 32. At the same time, FS 48 may store other parameters of the same metadata, which change less frequently, in Flash memory 32. The mTime and aTime parameters are addressed purely by way of example. Additionally or alternatively, FS 48 may store any other metadata parameters in NVDRAM 40.

In an embodiment, when the memory space in NVDRAM 40 is limited, FS 48 may decide which metadata parameters to store in NVDRAM using various cache-management schemes. Such schemes typically give preference to caching the more frequently-used parameters.

FIG. 4 is a flow chart that schematically illustrates a method for data storage, in accordance with yet another embodiment of the present invention. In this embodiment, FS 48 performs de-duplication when storing data in SSD 28. In a typical de-duplication process, the FS refrains from storing a data item (e.g., memory page) if Flash memory 32 already holds at least a predefined minimal number of identical copies of the data item (e.g., one copy).

In the disclosed embodiment, FS 48 uses NVDRAM 40 for temporary storage of data items while searching for existing copies of the data items in Flash memory 32. This solution improves the endurance of the Flash memory and reduces latency.

The method of FIG. 4 begins with FS 48 issuing a write command for writing a certain data item to SSD 28, at a writing step 100. At a temporary storage step 104, FS 48 temporarily stores the data item in NVDRAM 40 using the “second command.” Then, FS 48 searches for an existing copy of the data item (or some other predefined minimal number of identical copies, according to the redundancy requirements of computer 20), at a searching step 108.

If not found, as checked at a copy checking step 112, FS 48 copies the data item from NVDRAM 40 to Flash memory 32, e.g., using the “third command,” at a copying step 116. If found, FS 48 discards the copy stored in the NVDRAM, at a discarding step 120, and does not write the data item to Flash memory 32.

In some implementations, NVDRAM 40 is not atomically protected from power interruption. In other words, if power interruption occurs while data is being written to NVDRAM 40, part of the data may be written successfully while another part of the data may be lost or corrupted. This inconsistent intermediate state is highly undesired in many applications and should be avoided.

In some embodiments, FS 48 takes measures to mitigate power interruption that occurs during writing to NVDRAM 40. In these embodiments, when writing updated data using the “second command,” the FS does not overwrite the previous copy of the data in the NVDRAM, but rather writes the updated data to another location. If power interruption occurs while the updated data is being written, the write is declared failed and the FS reverts to the previous copy of the data. If no power interruption occurs while the updated data is being written, the write is declared successful.

In an example embodiment, FS 48 first copies the previous copy of the data to some other location, e.g., to a volatile DRAM in the SSD. The FS then updates the DRAM with the updated copy of the data (while the previous copy is intact in the NVDRAM). Then, the FS copies the updated copy of the data to the NVDRAM (to a different location than the previous copy of the data). When using this process, the previous copy of the data remains in the NVDRAM, until it is ensured that the updated copy is successfully stored in the NVDRAM as well. The FS typically marks the previous and updated copies with suitable validity markers that indicate, at any point in time, which is the valid copy.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus, comprising:
a storage device, comprising:
non-volatile storage, comprising non-volatile memory media; and
a Non-Volatile Dynamic Random Access Memory (NVDRAM); and
a processor, which is configured to run a software application that supports at least a first command for storing first information in the non-volatile storage of the storage device, and a second command for storing second information in the NVDRAM of the storage device.

2. The apparatus according to claim 1, wherein the NVDRAM comprises a volatile Dynamic Random Access Memory (DRAM) and circuitry for protecting content of the DRAM from power interruption.

3. The apparatus according to claim 1, wherein the processor further supports a third command for committing at least part of the second information from the NVDRAM to the non-volatile storage.

4. The apparatus according to claim 1, wherein the storage device comprises a controller, which is configured to communicate with the processor and which recognizes and supports the first and second commands.

5. The apparatus according to claim 1, wherein the storage device comprises a Solid State Drive (SSD), wherein the non-volatile memory media comprises Flash memory.

6. The apparatus according to claim 1, wherein the software application comprises a File System (FS).

7. The apparatus according to claim 1, wherein the processor, using the software application, is configured to format data for storage in memory blocks having a fixed size, to store the memory blocks in the non-volatile storage using the first command, and to accumulate remainders of the data that exceed an integer number of the memory blocks in the NVDRAM using the second command.

8. The apparatus according to claim 7, wherein the processor, using the software application, is configured to commit the accumulated remainders of the data to the non-volatile storage when a size of the accumulated remainders exceeds the fixed size of the memory blocks.

9. The apparatus according to claim 1, wherein the processor, using the software application, is configured to store data in the non-volatile storage using the first command, and to accumulate metadata relating to the data in the NVDRAM using the second command.

10. The apparatus according to claim 9, wherein the processor, using the software application, is configured to commit the accumulated metadata to the non-volatile storage when a size of the accumulated metadata exceeds a predefined size.

11. The apparatus according to claim 9, wherein the metadata accumulated in the NVDRAM comprises journaling information.

12. The apparatus according to claim 9, wherein the data stored in the non-volatile storage comprises a file, and wherein the metadata accumulated in the NVDRAM comprises at least one of a first indication of a most-recent time the file was accessed and a second indication of the most-recent time the file was modified.

13. The apparatus according to claim 1, wherein the processor, using the software application, is configured to initially store a data item in the NVDRAM using the second command, to check whether at least a predefined number of copies of the data item already exists in the non-volatile storage, and, if the predefined number of copies does not exist, to commit the data item from the NVDRAM to the non-volatile storage.

14. The apparatus according to claim 13, wherein the processor, using the software application, is configured to discard the data item from the NVDRAM if the predefined number of copies exists in the non-volatile storage.

15. A method, comprising:
running a software application on a processor, which communicates with a storage device, comprising:
non-volatile storage, comprising non-volatile memory media; and
a Non-Volatile Dynamic Random Access Memory (NVDRAM);
using a first command supported by the software application, storing first information in the non-volatile storage of the storage device;
using a second command supported by the software application, storing second information in the NVDRAM of the storage device; and
committing at least part of the second information from the NVDRAM to the non-volatile storage.

16. The method according to claim 15, wherein the NVDRAM comprises a volatile Dynamic Random Access Memory (DRAM) and circuitry for protecting content of the DRAM from power interruption.

17. The method according to claim 15, wherein running the software application comprises communicating with a controller of the storage device that recognizes and supports the first and second commands.

18. The method according to claim 15, wherein the storage device comprises a Solid State Drive (SSD), wherein the non-volatile memory media comprises Flash memory.

19. The method according to claim 15, wherein the software application comprises a File System (FS).

20. The method according to claim 15, wherein running the software application comprises formatting data for storage in memory blocks having a fixed size, wherein storing the first information comprises storing the memory blocks in the non-volatile storage using the first command, and wherein storing the second information comprises accumulating remainders of the data that exceed an integer number of the memory blocks in the NVDRAM using the second command.

21. The method according to claim 20, wherein committing the second information comprises committing the accumulated remainders of the data to the non-volatile storage when a size of the accumulated remainders exceeds the fixed size of the memory blocks.

22. The method according to claim 15, wherein storing the first information comprises storing data in the non-volatile storage using the first command, and wherein storing the second information comprises accumulating metadata relating to the data in the NVDRAM using the second command.

23. The method according to claim 22, wherein committing the second information comprises committing the accumulated metadata to the non-volatile storage when a size of the accumulated metadata exceeds a predefined size.

24. The method according to claim 22, wherein the metadata accumulated in the NVDRAM comprises journaling information.

25. The method according to claim 22, wherein the data stored in the non-volatile storage comprises a file, and wherein the metadata accumulated in the NVDRAM comprises at least one of a first indication of a most-recent time the file was accessed and a second indication of the most-recent time the file was modified.

26. The method according to claim 15, wherein storing the second information comprises initially storing a data item in the NVDRAM using the second command, and wherein committing the second information comprises checking whether at least a predefined number of copies of the data item already exists in the non-volatile storage, and, if the predefined number of copies does not exist, committing the data item from the NVDRAM to the non-volatile storage.

27. The method according to claim 26, and comprising discarding the data item from the NVDRAM if the predefined number of copies exists in the non-volatile storage.
